(19) United States
(12) Patent Application Publication
(10) Pub. No.: US 2007/0226732 A1
(43) Pub. Date: Sep. 27, 2007

(54) Flow chart programmable data collector

(75) Inventors: Michael B. O'Flaherty, Streetsboro, OH (US); Barry J. Markwitz, Solon, OH (US)

Correspondence Address: James A. Hudak, Esq., Suite #304, 29425 Chagrin Blvd., Cleveland, OH, 44122-4602, US

(73) Assignee: TimeKeeping Systems, Inc.

(21) Appl. No.: 11/375,941

(22) Filed: Mar. 16, 2006

(51) Int. Cl. G06F 9/445

(52) U.S. Cl. 717/174

(57) ABSTRACT

A programmable data collector that can interactively act with the person using same is disclosed. The logic responsible for the interactive ability of the data collector is programmed on a personal computer through a graphical flow-charting interface. The flow chart is processed by software that analyzes the flow chart and converts it into script that can run in the data collector. The script is loaded via a personal computer into the data collector where it is stored in nonvolatile memory. Once stored in the data collector, the script is executed by the data collector when an initiating event occurs.

### TECHNICAL FIELD

The present invention relates, in general, to a programmable data collector and, more particularly, to a programmable data collector for a guard tour that can interactively act with the officer conducting the tour so as to visually and/or audibly provide questions and instructions to the officer when on the guard tour.

### BACKGROUND ART

Present guard tour systems typically utilize checkpoints that an officer must visit while on a tour and a portable data collector that is carried by the officer and capable of reading each checkpoint's identification and storing a time stamp to indicate when each checkpoint's identification was read. These guard tour systems can verify whether an officer visits the checkpoints for which he or she is responsible, but the systems are usually capable of providing little more. Officers must often be trained with respect to each specific guard tour. For example, matters such as route information, tasks that must be performed at specific locations on the tour, and tasks that must be performed when certain incidents occur during a tour must often be memorized or carried by the officer in written form. In view of this, the efficiency of the officer may be adversely affected until he or she becomes familiar with procedures and other specifics of the guard tour.

### SUMMARY OF THE INVENTION

The present invention is an intelligent data collector that can interact with the officer through a logical series of questions and instructions to help insure that the proper procedures are followed during a guard tour. These questions and instructions can be tailored to answers given by the officer to questions that are posed by the data collector with respect to the tour, time, date, officer identification, incident, or any other variable to which the data collector has access. The questions and instructions can be displayed as text on a liquid crystal display or another type of display mounted on the data collector and the officer can “key in” the answers. Alternatively, the data collector can ask questions and give audible instructions by a synthesized voice, and answers can be expressed verbally by the officer, increasing speed and accuracy while permitting the officer to perform the tasks at hand.

The logic responsible for these interactive sessions is programmed on a personal computer by a supervisor through a graphical flow-charting interface, such as Microsoft Visio. This process involves dragging and dropping flow chart components such as data, process, decision, and display symbols into the flow chart, selecting reader variables, such as location or incident identifiers for comparison to entered values, and entering text to be displayed or spoken by the data collector when the flow chart logic takes a given path. The interface makes programming relatively easy and requires no knowledge of programming languages. When complete, the flow chart is processed by software that analyzes the flow chart and converts it into a form that can be executed by the data collector, such as program script, machine code, or the like. This executable logic is then loaded via a personal computer into the nonvolatile memory that is used by the data collector. Once stored in the nonvolatile memory, the executable logic is executed by the data collector when the logic's initiating event, such as the reading of an incident or an officer or location identifier, occurs.

In one embodiment, the first logic component of every flow chart refers to an initiating event. An initiating event is any event that the data collector is capable of detecting. Typical examples of an initiating event include the reading of an officer, location, or incident identifier by the data collector, a menu selection if the user interface device has such a capability, or passing through or near a defined location if the device is equipped with GPS or proximity reading technology. These initiating events are selected through the flow-charting interface from a predefined list of all possible initiating events. When the data collector detects a possible initiating event, it verifies whether scripts (program logic) associated with the initiating event exist in its nonvolatile memory. If such scripts exist, the data collector executes the associated script. If more than one script exists for the event and the scripts are not associated with one another, the scripts are executed in priority order if a priority is assigned, or in the order in which they are stored in the data collector if no priority is assigned. It is possible for one script to cause the execution of other scripts that are not necessarily associated with the initiating event.

The software of the present invention uses the flow chart symbols together with text and other information entered into the flow chart by the user to generate a script suitable for execution by the software of the data collector. The flow-charting interface provides extensive error checking and lists of available reader parameters such as time, date, location ID, incident ID, and the like, as well as standard fill-in templates when text must be specified within a flow chart symbol.

### BRIEF DESCRIPTION OF THE DRAWINGS

FIG. 1 illustrates sample symbols and scripting mechanisms utilized by the programmable data collector of the present invention.

FIG. 2 is a typical flow chart of the logic utilized by the programmable data collector of the present invention.

### DESCRIPTION OF THE PREFERRED EMBODIMENT

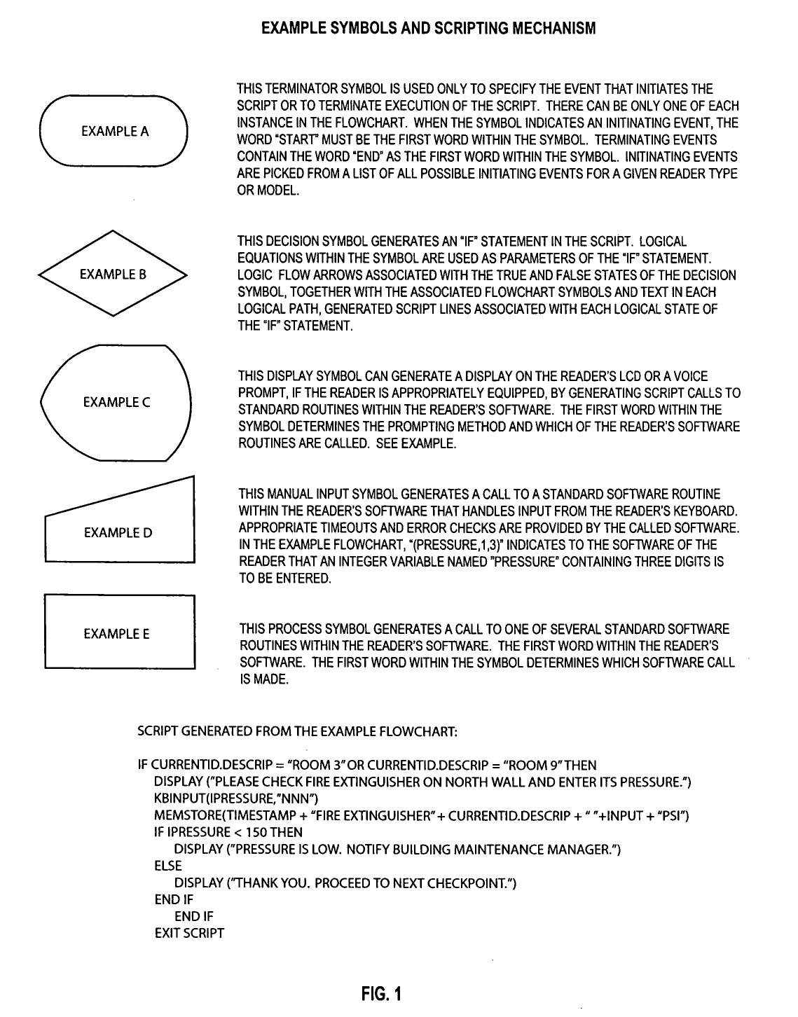

Referring now to the drawings where the illustrations are for the purpose of describing the preferred embodiment of the present invention and are not intended to limit the invention described herein. FIG. 1 illustrates sample symbols and scripting mechanisms utilized by the programmable data collector of the present invention. In this Figure, Example A is the terminator symbol which is used only to specify an event that initiates script or terminates execution of the script. There can be only one of each instance (initiation or termination) of this symbol in the flow chart. When this symbol indicates an initiating event, the word “Start” must be the first word within the symbol. Terminating events contain the word “End” as the first word within the symbol. Initiating events are selected from a list of all possible initiating events for a given data collector type or model.

Example B is the decision symbol that generates the “If” statement in the script. Logic equations within this symbol are used as parameters of the “If” statement. Logic flow arrows associated with the “true” and “false” states of the decision symbol, along with the associated flow chart symbols and text in each logic path, generate script lines with each logic state of the “If” statement.

Example C is the display symbol that can generate a display on the data collector's liquid crystal display or can produce a voice prompt, if the data collector is appropriately equipped, by generating script calls to standard routines within the data collector's software. The first word within this symbol determines the prompting method and which of the data collector's software routines are called.

Example D is the manual input symbol which generates a call to a standard software routine within the data collector's software that handles input from the data collector's keyboard. Appropriate timeouts and error checks are provided by the software that is selected.

Example E is the process symbol that generates a call to one of several standard software routines within the data collector's software. The first word within this symbol determines which software call is made.

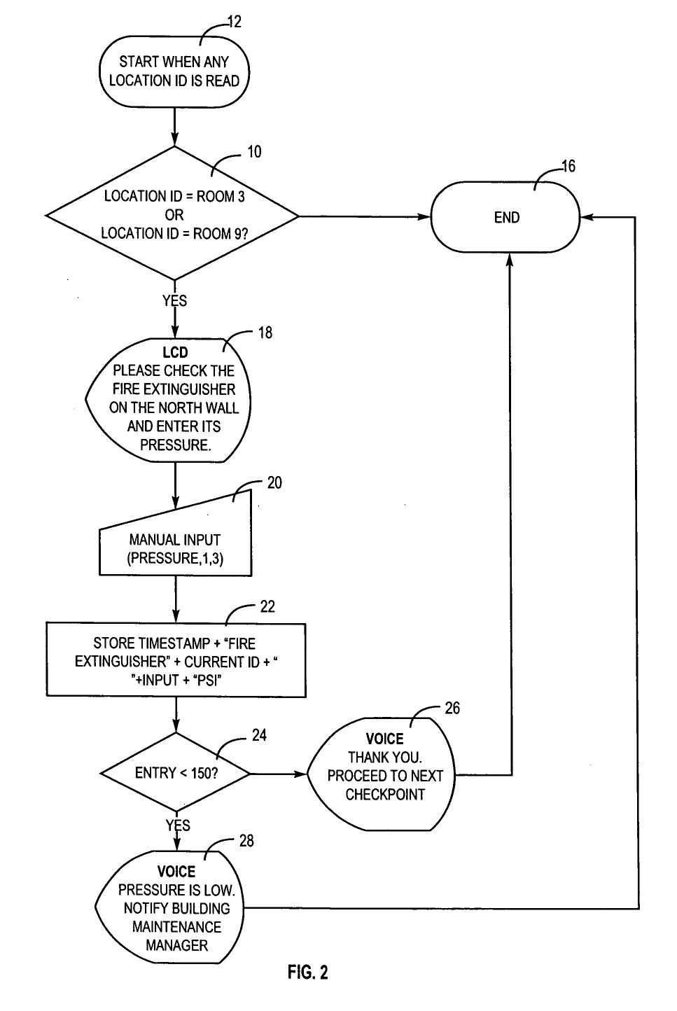

Also shown in FIG. 1 is the script that would be generated for a typical flow chart, such as the flow chart 10 shown in FIG. 2, which illustrates the logic that may be utilized by the programmable data collector of the present invention. The script generated by the scripting software may be human readable, as described in FIG. 1, or the script may be encoded, tokenized, in the form of machine code, or in other forms that are not readable by, or meaningful to, humans. In this flow chart 10, when an officer reads a location checkpoint associated with room 3 or room 9 of a specific facility, the logic prompts the officer to check the pressure within a fire extinguisher located on the north wall of the same room. In addition, the officer is asked to enter the pressure reading on each of the fire extinguishers. The desired pressure reading (e.g., 150 psi) is stored in the memory of the data collector. If the pressure reading is less than 150 psi, the officer is prompted to notify the building maintenance manager or supervisor.

Referring to the flow chart 10 in FIG. 2, the logic is started in block 12 when a location identification is read by the data collector. A determination is then made in block 14 as to whether the location is room 3 or room 9 of the facility. If the location is not room 3 or room 9, the logic is terminated in block 16. If the location is either room 3 or room 9, the officer is “prompted” on a liquid crystal display in the data collector to check the fire extinguisher at a particular location in that room and enter its pressure, as shown in block 18. The officer manually inputs (“keys in”) the pressure in the data collector, as shown in block 20, and the data collector stores time stamped data in its memory as to the location of the fire extinguisher and its pressure, as shown in block 22. A check is made in block 24 as to whether the pressure of the fire extinguisher is less than the desired pressure (e.g., 150 psi). If the pressure of the fire extinguisher is not less than 150 psi, a prompt is given to the officer in block 26 to proceed to the next checkpoint and the logic is terminated in block 16. If the pressure of the fire extinguisher is less than 150 psi, a prompt is given to the officer in block 28 to notify the building maintenance manager of this low pressure condition and the logic is terminated in block 16.

It should be noted that when an officer enters an incident into the data collector, the data collector may ask additional questions of the officer or may offer additional instructions to the officer. For example, when a particular incident is read, the data collector may ask the officer whether there were any other persons involved. If the officer answers “Yes”, the data collector may prompt the officer to enter the names of those persons and other information regarding those persons. If the officer answers “No”, the data collector may inquire about particular conditions, such as weather or lighting, or the like. The entered information might later be used in the creation of accident reports and the like.

In addition, the reading of a certain checkpoint may cause the data collector to prompt the officer to perform some additional activity relating to that location, such as checking a fire extinguisher, as in the previous example. This could take the form of a simple instruction for the officer or the data collector could ask the officer to enter particular data, such as a pressure gauge reading. If the reading entered by the officer exceeds or is below a predetermined level, the data collector may instruct the officer to notify the appropriate individual of this condition or to take other corrective action.

Certain modifications and improvements will occur to those skilled in the art upon reading the foregoing. It is understood that all such modifications and improvements have been deleted herein for the sake of conciseness and readability, but are properly within the scope of the following claims.

We claim:

1) A method for converting a flow chart into program code that can be executed by a data collection device having a memory associated therewith comprising the steps of:
a) creating an appropriate flow chart of a process or procedure in a flow charting language;
b) reading said flow chart utilizing software to produce a corresponding output that is executable by the data collection device;
c) loading said output into the memory of the data collection device; and
d) executing said output within the data collection device when an initiating event occurs.

2) The method as defined in claim 1 wherein said output is a program script.

3) The method as defined in claim 1 wherein, in step c, said output is loaded into the data collection device through the use of a computing device.

4) The method as defined in claim 1 further including, after step d, the step of providing information in visual form with respect to the process or procedure depicted in the flow chart.

5) The method as defined in claim 1 further including, after step d, the step of providing information in audible form with respect to the process or procedure depicted in the flow chart.
